(19) United States
(12) Patent Application Publication
(10) Pub. No.: US 2019/0132394 A1
(43) Pub. Date: May 2, 2019

(54) FACILITY APPARATUS AND FACILITY COMMUNICATION SYSTEM PROVIDED WITH SAME

(71) Applicant: Hitachi-Johnson Controls Air Conditioning, Inc., Tokyo (JP)

(72) Inventor: Yoshihiro MACHIDA, Tokyo (JP)

(21) Appl. No.: 16/094,889

(22) PCT Filed: Apr. 13, 2017
(86) PCT No.: PCT/JP2017/015146

§ 371 Date: Oct. 19, 2018

(30) Foreign Application Priority Data
Apr. 28, 2016 (JP) 2016-091252

(51) Int. Cl. H04L 29/08; H04L 5/18; H04L 12/841; G05D 23/19

(52) U.S. Cl. CPC H04L 67/12; G05D 23/1917; H04L 47/28; H04L 5/18

(57) ABSTRACT

The purpose of the present invention is to realize bidirectional communication in a facility communication system to which facility apparatuses having different communication speeds are connected. The purpose is achieved by a facility apparatuses that is connected to a facility communication network containing a mix of a first facility apparatus supporting a first communication speed and a second facility apparatus supporting a second communication speed, and that is configured so as to: output communication information indicating the start of communication at the second communication speed to the second facility apparatus through communication at the first communication speed; switch the communication speed by a high-low speed switching unit; output communication information by using communication at the second communication speed; and output communication information to the first facility apparatus through communication at the first communication speed.

### TECHNICAL FIELD

The present invention relates to a communication apparatus in an industrial facility.

### BACKGROUND ART

A communication network in an industrial facility handles a small amount of information such as operating status of facility equipment and instructions for controlling the equipment as information to be transferred by the network. Hence, a way of reducing cost using serial communication at a low rate as compared with Internet is known. In addition, enhancing the functionality of facility equipment and diversifying information to be transferred have lately been advanced.

As background art in the technical field to which the present invention pertains, there are publications as follows: Japanese Patent Application Laid-Open No. 2003-139375 (PTL 1) and Japanese Patent No. 4935821 (PTL 2). PTL 1 describes a method for reducing communication traffic in such a way that a communication apparatus responsible for control that mediates a protocol of communication with a host apparatus and a protocol of communication with a facility apparatus provides a plurality of communication nodes to the host apparatus and performs parallel processing. Furthermore, PTL 2 describes a transmission method that transmits a low-speed signal and a high-speed signal whose rate is an integral multiple of the rate of the low-speed signal in time-division multiplexing manner and the method is adapted to make even the equipment that only supports the low-speed signal extract a clock exactly and establish synchronization by superimposing the same pulse as the low-speed signal onto the high-speed signal

### CITATION LIST

### Patent Literature

PTL 1: Japanese Patent Application Laid-Open No. 2003-139375

PTL 2: Japanese Patent No. 4935821

### SUMMARY OF INVENTION

### Technical Problem

In PTL 1, low-speed communication is only described, but there is no description on a communication method in a case where facility apparatuses that support different communication speeds coexist.

In PTL 2, a transmission method that supports different communication speeds is described, but its purpose is synchronization in a system and there is no description on a method for carrying out bidirectional communication.

The present invention is intended to implement bidirectional communication in a facility communication system where facility apparatuses having different communication speeds are connected.

### Solution to Problem

To achieve the above-noted challenge, the present invention resides in, by way of example, a facility apparatus that is connected to a facility communication network in which a first facility apparatus supporting a first communication speed and a second facility apparatus supporting a second communication speed coexist, the facility apparatus comprising a communication control unit which controls communication functionality, a transmitting unit which transmits communication information, an output unit which outputs communication information transmitted from the transmitting unit to the facility communication network as a communication signal, an input unit which inputs a communication signal from the facility communication network as communication information, a receiving unit which receives communication information from the input unit, a high/low speed decision unit which decides whether or not communication is initiated at the second communication speed, based on received communication information, and a high/low speed switching unit which switches over an input/output signal speed, based on a result of decision made by the high/low speed decision unit, and the facility apparatus is configured to output communication information to initiate communication at the second communication speed to the second facility apparatus through communication at the first communication speed, switch over communication speed by the high/low speed switching unit, output communication information through communication at the second communication speed, and output communication information to the first facility apparatus through communication at the first communication speed.

### Advantageous Effects of Invention

According to the present invention, by implementing bidirectional communication even in a facility communication system where facility apparatuses having different communication speeds are interconnected, availability of the system can be enhanced.

### BRIEF DESCRIPTION OF DRAWINGS

FIG. 1 is a block diagram depicting a system configuration example in an example.

FIG. 2 is a block diagram depicting a configuration example of a low-speed apparatus in the example.

FIG. 3 is a block diagram depicting a configuration example of a high-speed apparatus in the example.

FIG. 4 is a diagram illustrating one example of a communication data format in the example.

FIG. 5 is a diagram illustrating one example of a state of a communication network in the example.

FIG. 6 is a diagram illustrating one example of a communication sequence in the example.

FIG. 7 is a diagram illustrating one example of a communication sequence in the example.

FIG. 8 is a diagram illustrating one example of a flowchart of transmission and receiving at a low-speed apparatus in the example.

FIG. 9 is a diagram illustrating one example of a flowchart of receiving at a high-speed apparatus in the example.

FIG. 10 is a diagram illustrating one example of a flowchart of transmission and receiving at a high-speed apparatus in the example.

FIG. 11 is a diagram illustrating one example of a flowchart of transmission and receiving at a high-speed apparatus in the example.

FIG. 12 is a diagram illustrating one example of a communication sequence for interrogating facility apparatuses to find out their states in the example.

FIG. 13 is a diagram representing one example of an apparatus information table in the example.

### DESCRIPTION OF EMBODIMENTS

In the following, examples of the present invention will be described with the aid of the drawings. Now, in the drawings, identical reference numerals denote identical or equivalent elements. In addition, the present invention is not intended to be limited to examples depicted.

### Example 1

The present example illustrates a method of communication between a facility communication apparatus (hereinafter referred to as a facility apparatus) that supports a low communication speed and a facility apparatus that supports a high communication speed.

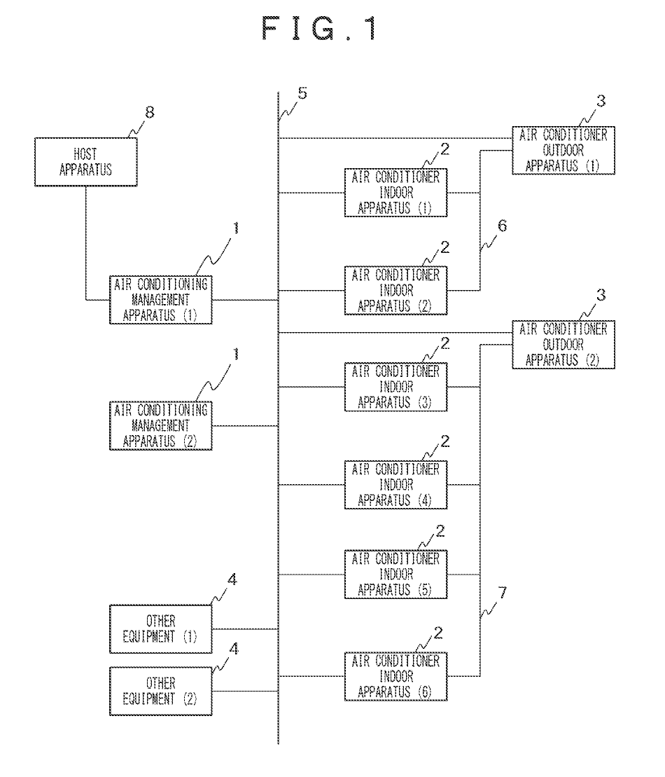

FIG. 1 is a system configuration example in the present example. In FIG. 1, reference numeral 1 denotes an air conditioning management apparatus; 2 denotes an air conditioner indoor apparatus; 3 denotes an air conditioner outdoor apparatus; 4 denotes other equipment such as lighting equipment and a security apparatus; 5 denotes a facility communication network; 6 denotes first refrigerant piping for supplying refrigerant gas from an air conditioner outdoor apparatus 3 (1) to air conditioner indoor apparatuses 2 (1) and (2); 7 denotes second refrigerant piping for supplying refrigerant gas from an air conditioner outdoor apparatus 3 (2) to air conditioner indoor apparatuses 2 (3) to (6); 8 denotes a host apparatus.

Air conditioning management apparatuses 1, air conditioner indoor apparatuses 2, air conditioner outdoor apparatuses 3, and other equipment 4 are connected by the facility communication network 5 so that they will communicate one another. Now, equipment that is connected to the facility communication network 5 is defined as facility apparatuses and, for example, the air conditioning management apparatuses 1, air conditioner indoor apparatuses 2, air conditioner outdoor apparatuses 3, and other equipment 4 are all the facility apparatuses.

An air conditioning management apparatus 1 is connected to the host apparatus 8 such as a building management apparatus by a network different from the facility communication network 5; it receives an equipment control directive issued to the air conditioning management apparatus 1 for, e.g., optimizing consumed power of a building as a whole and performs control of the facility apparatuses via the facility communication network 5, based on the equipment control directive.

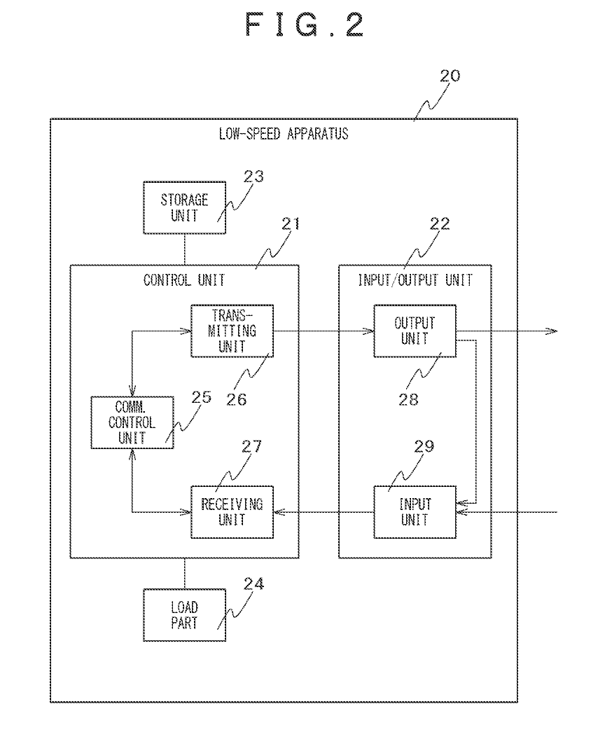

FIG. 2 is a block diagram depicting a configuration example of a low-speed apparatus 20 in the present example. The facility apparatuses, i.e., the equipment which is connected to the facility communication network 5, depicted in FIG. 1 are low-speed apparatuses 20 or high-speed apparatuses 30 which will be described later; a low-speed or high-speed apparatus is not limited to a particular apparatus.

In FIG. 2, the low-speed apparatus 20 includes a control unit 21, an input/output unit 22, a storage unit 23, and a load part 24. The load part 24 is, for example, a display in the case of an air conditioning management apparatus 1, a fan in the case of an air conditioner indoor apparatus 2, a compressor in the case of an air conditioner outdoor apparatus 3, lighting tubes, image capturing sensors, etc. in the case of other equipment 4. The control unit 21 includes a communication control unit 25, a transmitting unit 26, and a receiving unit 27 and the input/output unit 22 includes an output unit 28 and an input unit 29.

The low-speed apparatus 20 inputs a communication signal which has been received by the input unit 29 from the facility communication network 5 to the receiving unit 27 as data and, based on received information received by the receiving unit 27, the communication control unit 25 inputs transmission information from the transmitting unit 260 to the output unit 28. The output unit 28 outputs this information as a transmission signal to the facility communication network 5. Now, the transmission signal which is output from the output unit 28 is also input to the input unit 29 and the communication control unit 25 makes sure whether transmission information transmitted from the transmitting unit 26 has been output correctly.

The communication control unit 25 may store received information once received and transmission information once transmitted into the storage unit 23. Also, the communication control unit 25 may transmit transmission information spontaneously based on status of the load part 24.

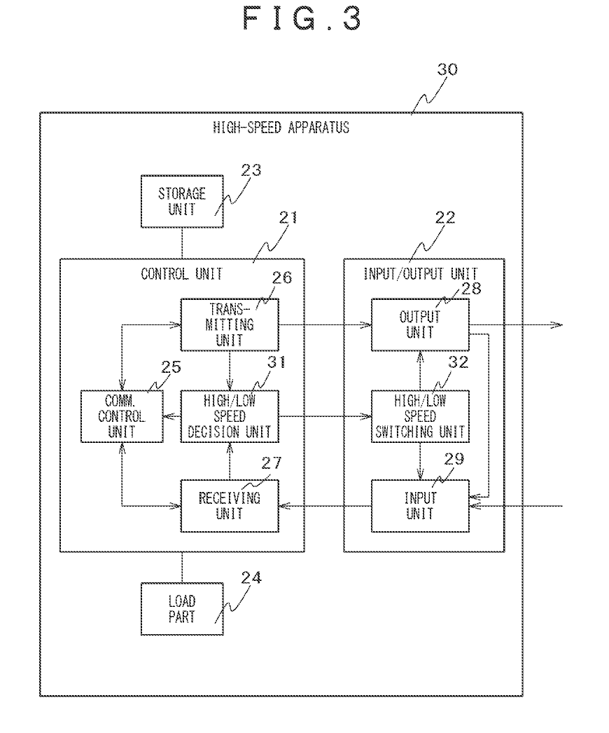

FIG. 3 is a block diagram depicting a configuration example of a high-speed apparatus 30 in the present example. The facility apparatuses, i.e., the equipment which is connected to the facility communication network 5, depicted in FIG. 1 are low-speed apparatuses 20 mentioned above or high-speed apparatuses 30; a low-speed or high-speed apparatus is not limited to a particular apparatus. In FIG. 3, components that function in the same way as in the low-speed apparatus 20 depicted in FIG. 2 are assigned identical reference numerals and their description is omitted.

In FIG. 3, the control unit 21 includes a high/low speed decision unit 31 and the input/output unit 22 includes a high/low speed switching unit 32. The receiving unit 27 inputs received information to the high/low speed decision unit 31 and the high/low speed decision unit 31 signals the communication control unit 25 and the high/low speed switching unit 32 to perform high-speed communication, if high-speed communication should be performed based on the received information it received. The high/low speed switching unit 32 signals the output unit 28 and the input unit 29 to transmit and receive a high-speed signal. By the signaling to perform high-speed communication, the communication control unit 25 inputs transmission information from the transmitting unit 26 to the output unit 28 and the output unit 28 outputs this information as a transmission signal to the facility communication network 5.

In a case where the apparatus itself needs to perform high-speed communication independently of received information it received and a predefined condition which will be described later is fulfilled, the communication control unit 25 communicates a signal to switch from low-speed communication to high-speed communication to the transmitting unit 26 and the receiving unit 27, and the transmitting unit 26 and the receiving unit 27 signal the high/low speed decision unit 31 to switch over to high-speed communication. The high/low speed decision unit 31 signals the high/low speed switching unit 32 to switch over to high-speed communication and the high/low speed switching unit signals the output unit 28 and the input unit 29 to transmit and receive a high-speed communication signal.

In addition, in a case where a predefined condition which will be described later is fulfilled, the communication control unit 25 signals the transmitting unit 26 and the receiving unit 27 to switch from high-speed communication to low-speed communication, and the transmitting unit 26 and the receiving unit 27 signal the high/low speed decision unit 31 to switch over to low-speed communication. The high/low speed decision unit 31 signals the high/low speed switching unit 32 to switch over to low-speed communication and the high/low speed switching unit signals the output unit 28 and the input unit 29 to transmit and receive a low-speed communication signal.

Now, by switching over between high-speed communication and low-speed communication, the high-speed apparatus 30 can communicate with a low-speed apparatus 20 through low-speed communication and communicate with another high-speed apparatus through high-speed communication.

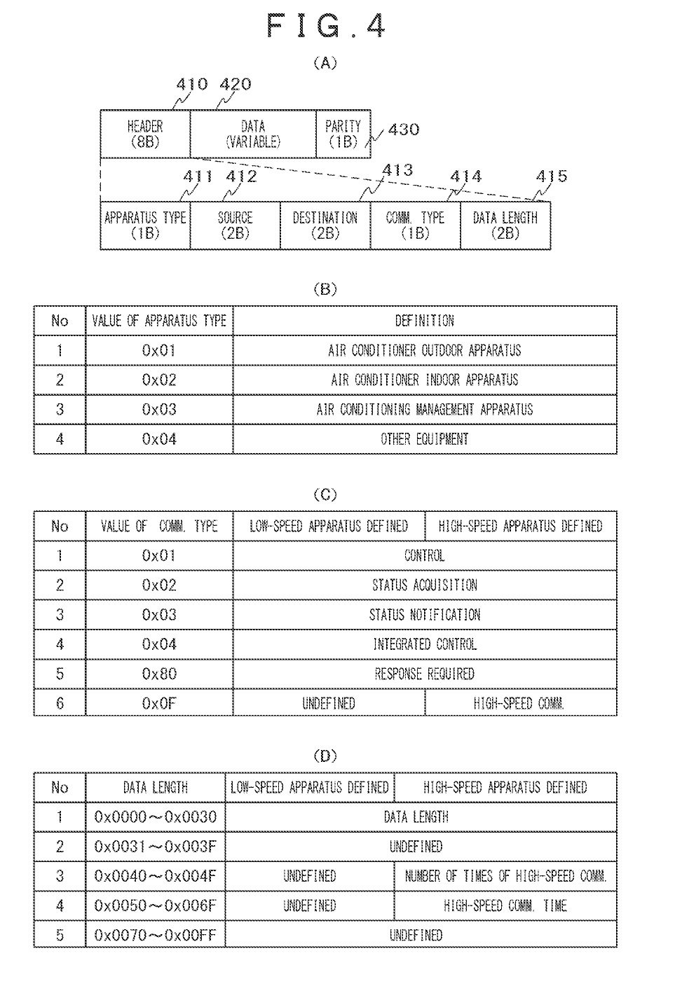

FIG. 4 is a diagram illustrating one example of a communication data format in the present example. FIG. 4(A) illustrates an example of the data format structure. In FIG. 4(A), the data format is comprised of a header part 410 of eight bytes, a data part 420 of variable size, and a parity part 430 of one byte. The header part 410 is comprised of the following fields: apparatus type 411 of one byte; source address 412 of two types; destination address 413 of two bytes; communication type 414 of one byte; and data length 415 of two bytes indicating the data length of the data part 420. In the source address 412, described is an address specific to each apparatus assigned to a source apparatus that transmits communication data. In the destination address 413, the address of a destination apparatus is described that is a peer to which the source apparatus transmitted communication data. If the source apparatus is to transmit communication data to all facility apparatuses connected to the facility communication network without specifying a particular destination, it will specify a multicast address of 0xFFFF in the destination address. Now, grouping may be done using particular bits.

FIG. 4(B) illustrates an example of information for apparatus type 411. In FIG. 4(B), as the apparatus type 411, the apparatus type of the source apparatus is described. 0x01 represents an air conditioner outdoor apparatus, 0x02 represents an air conditioner indoor apparatus, 0x03 represents an air conditioning management apparatus, and 0x04 represents other equipment. Now, any other value of apparatus type may be assigned to other equipment according to type of facility.

FIG. 4(C) illustrates an example of information for communication type 414. In FIG. 4(C), as the communication type 414, the purpose of communication data is described. 0x01 represents control of equipment, 0x02 represents acquisition of equipment status, 0x03 represents notification of status of the source equipment, and 0x04 represents integrated control of equipment under control. 0x80 represents that a response to communication data is required and 0x00 represents that a response is not required. By logical addition of the values of four least significant bits of control, status acquisition, status notification, integrated control, respectively, as mentioned above, if, for example, 0x84 is obtained as a value of communication type, it represents that a response is required and integrated control is performed; if 0x04 is obtained, it represents that a response is not required and integrated control is performed. 0x0F is an undefined value for a low-speed apparatus 20 and represents that communication subsequent to transmission of the header 410 is high speed for a high-speed apparatus 30.

FIG. 4(D) illustrates an example of information for data length 415. In FIG. 4(D), a value range from 0x0000 to 0x0030 represents data length. A value range from 0x0031 to 0x003F is undefined. A value range from 0x0040 to 0x004F is an undefined value for a low-speed apparatus 20 and represents the number of times of high-speed communication, which will be described later, for a high-speed apparatus 30. Now, as for the number of times of high-speed communication, upon the elapse of a predetermined time, a period of high-speed communication expires and communication transits into a low-speed communication state. A value range from 0x0050 to 0x006F is an undefined value for a low-speed apparatus 20 and represents and represents a high-speed communication time (hereinafter, also referred to as a high-speed communication period) for a high-speed apparatus 30. A value range from 0x0070 to 0x00FF is undefined.

Now, the same data format may be used for low-speed and high-speed communication. High-speed communication can be performed in two ways: in one way, only the header part 410 is transmitted through low-speed communication, as will be described later, followed by transmitting the data part 420 and the parity part 430 through high-speed communication; in the other way, the data format including the header part 410 is transmitted through high-speed communication.

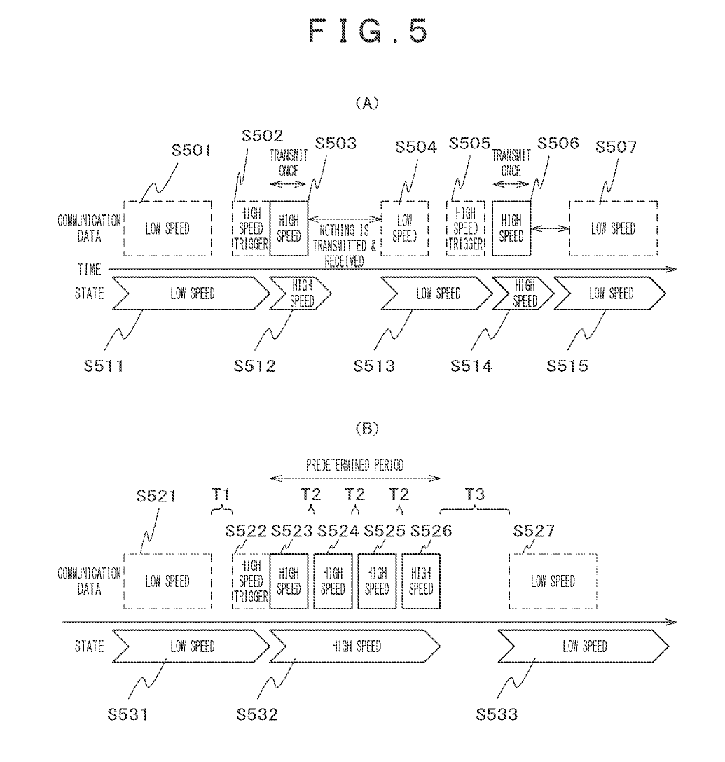

FIG. 5 is a diagram illustrating one example of a state of the communication network in the present example. FIG. 5 plots communication data that is transmitted and received over the facility communication network and a state of the network along the time axis. FIG. 5(A) illustrates an example in which high-speed communication is performed only once in a sequence of transmission, and FIG. 5(B) illustrates an example in which high communication is performed multiple times.

In FIG. 5(A), a case where the facility communication network 5 is normally placed in a state of low-speed communication is assumed. First, low-speed communication S501 is performed to transmit data consisting of the header part 410, data part 420, and parity part 430. When a certain high-speed apparatus 30 wants to perform high-speed communication, it transmits communication data in which 0x0F has been set in the communication type of the header part 410 (such data will be hereinafter referred to as a high speed trigger) through low-speed communication (S502). Until the high speed trigger has been transmitted, the facility communication network 5 remains in the state of low-speed communication S511. On an apparatus whose address matches the destination address 413 described in the header part 410, the high/low speed switching unit 32 signals the input unit 29 to receive a high-speed signal and the apparatus waits for receiving a high-speed signal. Because the high speed trigger is an undefined value for a low-speed apparatus 20, such apparatus performs nothing even when receiving it

The high-speed apparatus 30 transmits high-speed communication data S503 following the high speed trigger. The high-speed communication data S503 may include a header part 410 again. Until the high-speed communication data has been transmitted, the facility communication network 5 remains in a state of high-speed communication S512. After that, if nothing is transmitted and received for a predetermined time, the facility communication network 5 returns to the state of low-speed communication S513 and low-speed communication S504 is performed. In this way, communication at different communication speeds can be implemented by using a high speed trigger and switching from low-speed communication to high-speed communication even in the facility communication network in which low-speed and high-speed apparatuses coexist.

In FIG. 5(B), an example in which high-speed communication is performed multiple times is described. As is the case in FIG. 5(A), the facility communication network 5 is normally placed in the state of low-speed communication. First, low-speed communication S501 is performed to transmit data consisting of the header part 410, data part 420, and parity part 430. When a certain high-speed apparatus 30 wants to perform high-speed communication for a given period, it transmits a high speed trigger (S522) in which 0x0F has been set in the communication type of the header part 410 and the number of times of high-speed communication using a value range from 0x0040 to 0x006F or a high-speed communication time using a value range from 0x0050 to 0x006F has been specified in the data length through low-speed communication. Until the high speed trigger has been transmitted, the facility communication network 5 remains in the state of low-speed communication S511. On all high-speed apparatus having received the high speed trigger, the high/low speed switching unit 32 signals the input unit 29 to receive a high-speed signal and these apparatuses wait for receiving a high-speed signal. Because the high speed trigger is an undefined value for a low-speed apparatus 20, such apparatus performs nothing even when receiving it

The high-speed apparatus 30 that wants to perform transmission transmits high-speed communication data S523 following the high speed trigger. The high-speed communication data S523 may include a header part 410 again. After that, high-speed communications S524 to S526 are performed within a period described in the high speed trigger S522. Within the period described in the high speed trigger S522, any peer of high-speed apparatus may perform high-speed communication. Until high-speed communication data up to S526 has been transmitted, the facility communication network 5 remains in the state of high-speed communication (S532). After that, if nothing is transmitted and received for a predetermined time, the facility communication network 5 returns to the state of low-speed communication S533 and low-speed communication S527 is performed.

Now, predetermined periods for which the network is not in use are set as follows: T1 between the low-speed communication S521 and the high speed trigger transmission S522; T2 between the high-speed communication S523 and the high-speed communication S524; and T3 between the high-speed communication S526 and the low-speed communication S527. T1 and T3 values are set equal or T1 is set smaller than T3. A T2 value is set smaller than T3. By setting the T2 value smaller than the T3 value, it can be avoided that a low-speed apparatus performs data transmission during a period of high-speed communication. When the period T3 for which the network is not in use has come, a period of high-speed communication has terminated and a return to a period of low-speed communication can be made.

In the way described above, it is enabled to perform successive high-speed communications without switching over from low-speed communication to high-speed communication using a high speed trigger each time high-speed communication is performed.

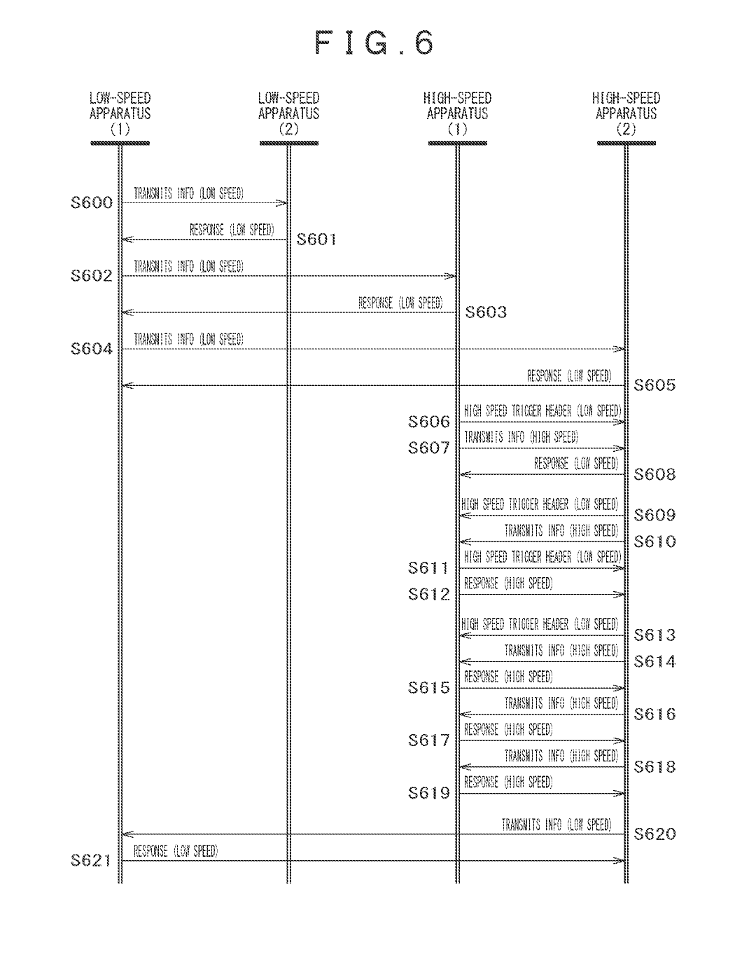

FIG. 6 is a diagram illustrating one example of a sequence of one-to-one communication among facility apparatuses in the present example. Respective steps in FIG. 6 are described below.

S600: A low-speed apparatus (1) transmits information to a low-speed apparatus (2) through low-speed communication using a low-speed data format comprised of the header part 410, data part 420, and parity 430.
S601: Based on communication information received from the low-speed apparatus (1), the low-speed apparatus (2) transmits a response to the low-speed apparatus (1) through low-speed communication using the low-speed data format comprised of the header part 410, data part 420, and parity 430.
S602: The low-speed apparatus (1) transmits information to a high-speed apparatus (1) through low-speed communication using the low-speed data format comprised of the header part 410, data part 420, and parity 430.
S603: Based on communication information received from the low-speed apparatus (1), the high-speed apparatus (1) transmits a response to the low-speed apparatus (1) through low-speed communication using the low-speed data format comprised of the header part 410, data part 420, and parity 430.
S604: The low-speed apparatus (1) transmits information to a high-speed apparatus (2) through low-speed communication using the low-speed data format comprised of the header part 410, data part 420, and parity 430.
S605: Based on communication information received from the low-speed apparatus (1), the high-speed apparatus (2) transmits a response to the low-speed apparatus (1) through low-speed communication using the low-speed data format comprised of the header part 410, data part 420, and parity 430.
S606: The high-speed apparatus (1) transmits a high speed trigger to the high-speed apparatus (2) through low-speed communication using the low-speed data format comprised of the header part 410 in which a high speed trigger has been described.
S607: The high-speed apparatus (1) transmits information to the high-speed apparatus (2) through high-speed communication using a high-seed data format comprised of the header part 410, data part 420, and parity 430.
S608: Based on communication information received from the high-speed apparatus (1), the high-speed apparatus (2) transmits a response to the high-speed apparatus (1) through low-speed communication using the low-speed data format comprised of the header part 410, data part 420, and parity 430.
S609: The high-speed apparatus (2) transmits a high speed trigger to the high-speed apparatus (1) through low-speed communication using the low-speed data format comprised of the header part 410 in which a high speed trigger has been described.
S610: The high-speed apparatus (2) transmits information to the high-speed apparatus (1) through high-speed communication using the high-seed data format comprised of the header part 410, data part 420, and parity 430.
S611: The high-speed apparatus (1) transmits a high speed trigger to the high-speed apparatus (2) through low-speed communication using the low-speed data format comprised of the header part 410 in which a high speed trigger has been described.
S612: Based on communication information received from the high-speed apparatus (2), the high-speed apparatus (1) transmits a response to the high-speed apparatus (2) through high-speed communication using the high-speed data format comprised of the header part 410, data part 420, and parity 430.
S613: The high-speed apparatus (2) transmits a high speed trigger to the high-speed apparatus (1) through low-speed communication using the low-speed data format comprised of the header part 410 in which a high speed trigger with a period specified has been described.
S614: The high-speed apparatus (2) transmits information to the high-speed apparatus (1) through high-speed communication using the high-speed data format comprised of the header part 410, data part 420, and parity 430.
S615: Based on communication information received from the high-speed apparatus (2), the high-speed apparatus (1) transmits a response to the high-speed apparatus (2) through high-speed communication using the high-speed data format comprised of the header part 410, data part 420, and parity 430.
S616: The high-speed apparatus (2) transmits information to the high-speed apparatus (1) through high-speed communication using the high-speed data format comprised of the header part 410, data part 420, and parity 430.
S617: Based on communication information received from the high-speed apparatus (2), the high-speed apparatus (1) transmits a response to the high-speed apparatus (2) through high-speed communication using the high-speed data format comprised of the header part 410, data part 420, and parity 430.
S618: The high-speed apparatus (2) transmits information to the high-speed apparatus (1) through high-speed communication using the high-speed data format comprised of the header part 410, data part 420, and parity 430.
S619: Based on communication information received from the high-speed apparatus (2), the high-speed apparatus (1) transmits a response to the high-speed apparatus (2) through high-speed communication using the high-speed data format comprised of the header part 410, data part 420, and parity 430.
S620: The high-speed apparatus (2) makes sure that the facility communication network is not in use for a predetermined time T3, as presented in FIG. 5(B), and transmits information to the low-speed apparatus (1) through low-speed communication using the low-speed data format comprised of the header part 410, data part 420, and parity 430.
S621: Based on communication information received from the high-speed apparatus (2), the low-speed apparatus (1) transmits a response to the high-speed apparatus through low-speed communication using the low-speed data format comprised of the header part 410, data part 420, and parity 430.

In the way described above, it is possible to perform communication between low-speed apparatuses through the use of low-speed communication and it is possible to perform communication between a low-speed apparatus and a high-speed apparatus through the use of low-speed communication. Between high-speed communication apparatuses, information communication is performed through high-speed communication and a response is transmitted through low-speed communication, thereby enabling transmission of large volume information at high speed. Between high-speed communication apparatuses, information communication is performed through high-speed communication and a response is transmitted through high-speed communication, thereby enabling transmission and receiving of large volume information at high speed. By setting a period of high-speed communication, communication can be performed without transmitting a high speed trigger through low-speed communication each time between high-speed communication apparatuses.

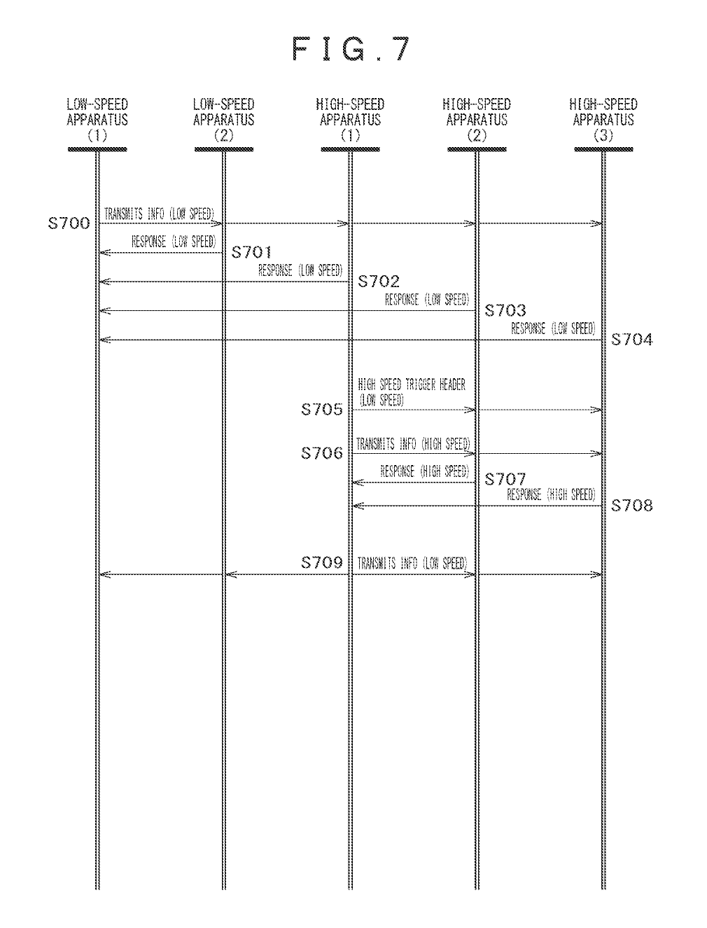

FIG. 7 is a diagram illustrating one example of a sequence of one-to-multiple communication among facility apparatuses in the present example. Respective steps in FIG. 7 are described below.

S700: A low-speed apparatus (1) multicasts information to all destinations through low-speed communication using a low-speed data format comprised of the header part 410 having a value representing that a response is required described in the communication type 414 and multicast addresses specified in the destination address 413 field, the data part 420, and parity 430.
S701: Based on multicast communication information received from the low-speed apparatus (1), a low-speed apparatus (2) transmits a response to the low-speed apparatus (1) through low-speed communication using the low-speed data format comprised of the header part 410, data part 420, and parity 430.
S702: Based on multicast communication information received from the low-speed apparatus (1), a high-speed apparatus (1) transmits a response to the low-speed apparatus (1) through low-speed communication using the low-speed data format comprised of the header part 410, data part 420, and parity 430.
S703: Based on multicast communication information received from the low-speed apparatus (1), a high-speed apparatus (2) transmits a response to the low-speed apparatus (1) through low-speed communication using the low-speed data format comprised of the header part 410, data part 420, and parity 430.
S704: Based on multicast communication information received from the low-speed apparatus (1), a high-speed apparatus (3) transmits a response to the low-speed apparatus (1) through low-speed communication using the low-speed data format comprised of the header part 410, data part 420, and parity 430. The low-speed apparatus (2) and high-speed apparatuses (1) to (3) each have an offset time predetermined based on the address of each apparatus and transmit a response, the offset time meaning a duration from having received the information until transmitting a response. Each apparatus transmits a response at a different time, so that a communication collision because of multicast responses can be avoided.
S705: The high-speed apparatus (1) transmits a high speed trigger through low-speed communication using the low-speed data format comprised of the header part 410 having a value representing that a response is required specified in the communication type 414 and multicast addresses specified in the destination address 413 and the header part 410 in which a high speed trigger with a period specified has been described in the data length 415 field.
S706: The high-speed apparatus (1) multicasts information to all destinations through high-speed communication using a high-speed data format comprised of the header part 410, data part 420, and parity 430.
S707: Based on communication information received from the high-speed apparatus (1), the high-speed apparatus (2) transmits a response to the high-speed apparatus (1) through high-speed communication using the high-speed data format comprised of the header part 410, data part 420, and parity 430.
S708: Based on communication information received from the high-speed apparatus (1), the high-speed apparatus (3) transmits a response to the high-speed apparatus (1) through high-speed communication using the high-speed data format comprised of the header part 410, data part 420, and parity 430.
S709: The high-speed apparatus (1) makes sure that the facility communication network is not in use for a predetermined time T3, as presented in FIG. 5(B), and multicasts information to all destinations through low-speed communication using the low-speed data format comprised of the header part 410 having multicast addresses specified in the destination address 413 field, the data part 420, and parity 430.

In the way described above, it is possible to perform multicast communication between low-speed apparatuses through the use of low-speed communication and it is possible to perform multicast communication between a low-speed apparatus and a high-speed apparatus through the use of low-speed communication. Between high-speed communication apparatuses, by setting a period of high-speed communication, multicast communication can be performed without transmitting a high speed trigger through low-speed communication each time between high-speed communication apparatuses.

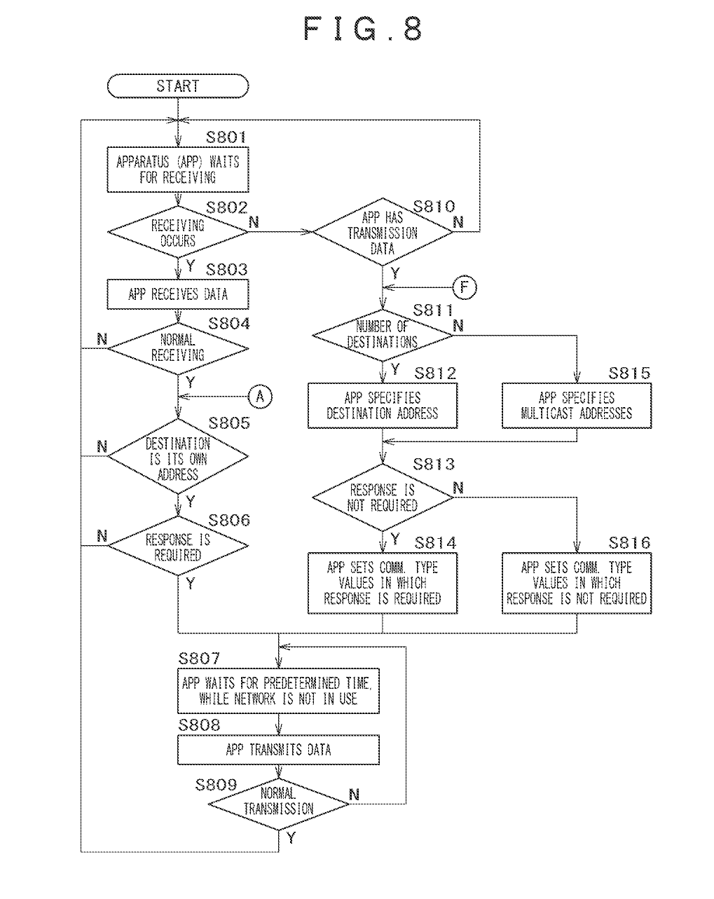

FIG. 8 is a diagram illustrating one example of a flowchart of transmission and receiving at a low-speed apparatus in the present example. Respective steps in FIG. 8 are described below.

S801: The apparatus waits for receiving a communication. S802: When receiving occurs, the apparatus proceeds to S803. If receiving does not occur, the apparatus proceeds to S810.
S803: The apparatus receives data.
S804: The apparatus checks to see whether the received data is normal. If the data is normal, the apparatus proceeds to S805; if the data is abnormal, the apparatus returns to S801.
S805: The apparatus checks to see whether an address described in the destination address 413 in the received data is its own address. If the described address is its own address or multicast address, the apparatus proceeds to S806; if the address differs, the apparatus returns to S801.
S806: The apparatus checks to see whether the received data requires a response. If a response is required, the apparatus performs processing based on the received data and, then, proceeds to S807. If a response is not required, the apparatus performs processing based on the received data and, then, returns to S801.
S807: The apparatus waits for a predetermined time T3, while the facility communication network is not in use. S808: The apparatus transmits data.
S809: The apparatus checks to see whether normal transmission of data is successful. If normal transmission is successful, the apparatus returns to S801; if normal transmission is unsuccessful, the apparatus returns to S807 for retransmission. Now, if normal transmission is unsuccessful even though retransmission is repeated plural times, the apparatus terminates retransmission, regarding this situation as an abnormal state.
S810: The apparatus checks to see whether information transmission from it is required. If transmission is required, the apparatus proceeds to S811; if transmission is not required, the apparatus returns to S801.
S811: The apparatus checks the number of destinations to which it will transmit information. If there is one destination, the apparatus proceeds to S812; if there are plural destinations, the apparatus proceeds to S815.
S812: The apparatus describes a destination address in the header part 410.
S813: The apparatus checks to see whether transmission information requires a response. If a response is required, the apparatus proceeds to S814; if a response is not required, the apparatus proceeds to S816.
S814: The apparatus describes a value representing that a response is required and other necessary values of type in the communication type 414 field.
S815: The apparatus describes multicast addresses in the header part 410.
S816: The apparatus does not describe a value representing that a response is required, but describes other necessary values of type in the communication type 414 field.

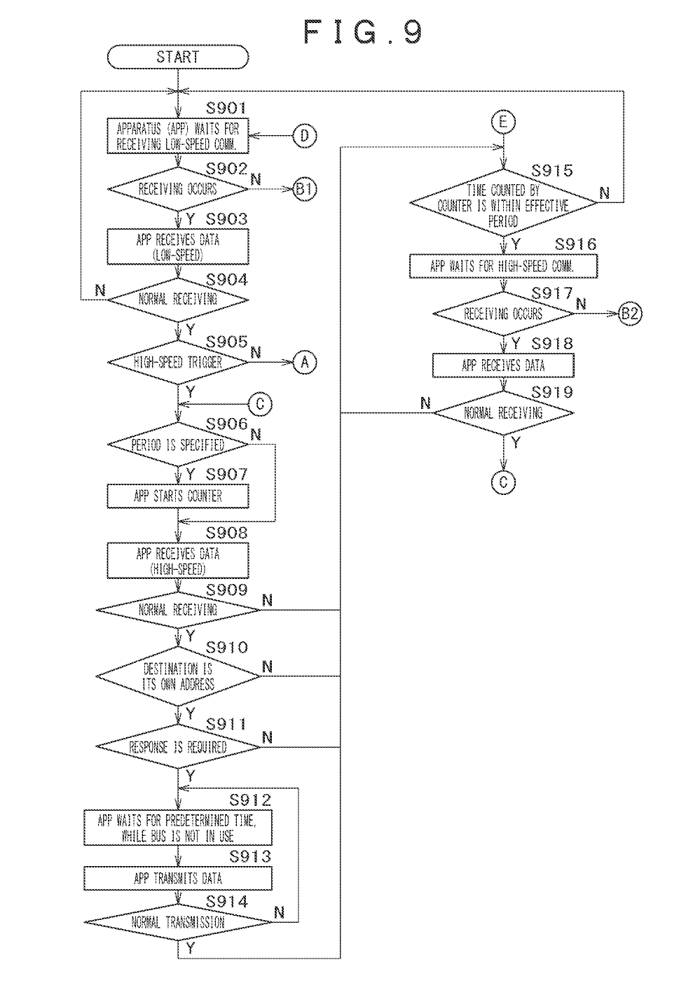

FIG. 9 is a diagram illustrating one example of a flowchart of receiving at a high-speed apparatus in the present example. Respective steps in FIG. 9 are described below.

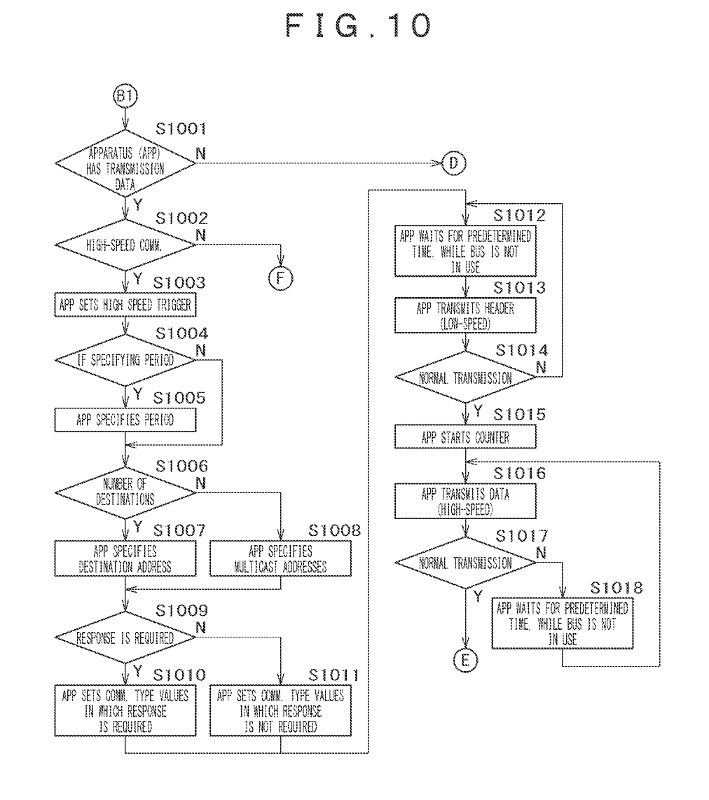

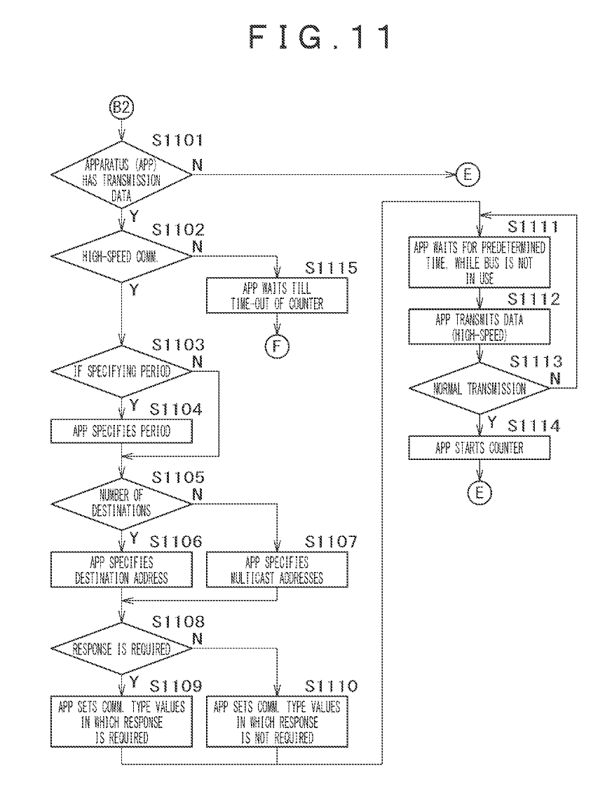

S901: The apparatus waits for receiving a low-speed communication.
S902: When receiving of low-speed communication data occurs, the apparatus proceeds to S903. If receiving does not occur, the apparatus proceeds to B1 (S1001 in FIG. 10).
S903: The apparatus receives low-speed communication data.
S904: The apparatus checks to see whether the received data is normal. If the data is normal, the apparatus proceeds to S905; if the data is abnormal, the apparatus returns to S901.
S905: If a high speed trigger is described in the received data, the apparatus proceeds to S906; if it is not described, the apparatus returns to S901 instead of proceeding to the transmission and receiving flow at a low-speed apparatus illustrated in FIG. 8, as marked with A (S805), and returning to S801.
S906: The apparatus checks to see whether a period of high-speed communication is specified in the received high speed trigger. If the period is specified, the apparatus proceeds to S907; if the period is not specified, the apparatus proceeds to S908.
S907: The apparatus starts a counter for the high-speed communication period. The apparatus always monitors the counter separately from this flowchart for time counting and counting the number of times that other apparatuses perform high-speed transmission and receiving and changes the counter value accordingly.
S908: The apparatus receives high-speed communication data.
S909: The apparatus checks to see whether the received data is normal. If the data is normal, the apparatus proceeds to S910; if the data is abnormal, the apparatus proceeds to S915.
S910: The apparatus checks to see whether an address described in the destination address 413 in the received data is its own address. If the described address is its own address or multicast address, the apparatus proceeds to S911; if the address differs, the apparatus proceeds to S915.
S911: The apparatus checks to see whether the received data requires a response. If a response is required, the apparatus performs processing based on the received data and, then, proceeds to S912. If a response is not required, the apparatus performs processing based on the received data and, then, proceeds to S915.
S912: The apparatus waits for a predetermined time T1, while the facility communication network is not in use.
S913: The apparatus transmits response data through low-speed communication.
S914: The apparatus checks to see whether normal transmission of response data is successful. If normal transmission is successful, the apparatus proceeds to S915; if normal transmission is unsuccessful, the apparatus returns to S912 for retransmission. Now, if normal transmission is unsuccessful even though retransmission is repeated plural times, the apparatus terminates retransmission, regarding this situation as an abnormal state.
Now, processing in a case where a period of high-speed communication is not specified in S907 has been described in S912 to S914. However, if a period of high-speed communication is specified in S907 and it is now within the period of high-speed communication, the time to wait will be T2, while the facility communication network is not in use in S912, and the apparatus will transmit response data through high-speed communication in S913.
S915: The apparatus checks to see whether time counted by the counter is within an effective period. If the time is within the effective period, the apparatus proceeds to S916; if the time is out of the effective period, the apparatus returns to S901.
S916: The apparatus waits for receiving a high-speed communication.
S917: When receiving of high-speed communication data occurs, the apparatus proceeds to S918. If receiving does not occur, the apparatus proceeds to B2 (S1101 in FIG. 11).
S918: The apparatus receives high-speed communication data.
S919: The apparatus checks to see whether the received data is normal. If the data is normal, the apparatus proceeds to C (S906); if the data is abnormal, the apparatus returns to S915.

FIG. 10 is a diagram illustrating one example of a flowchart of first-time transmission at a high-speed apparatus in the present example. Respective steps in FIG. 10 are described below.

S1001: The apparatus checks to see whether information transmission from it is required. If transmission is required, the apparatus proceeds to S1002; if transmission is not required, the apparatus returns to D (S901 in FIG. 9).
S1002: The apparatus proceeds to S1003 if performing high-speed communication or proceeds to F (S811 in FIG. 8) if performing low-speed communication, performs processing as is the case in low-speed communication, and returns to S901 when proceeding to S801.
S1003: The apparatus sets a high-speed communication trigger in the communication type 414 field.
S1004: The apparatus proceeds to S1005 if specifying a period or proceeds to S1006 if not specifying a period.
S1005: The apparatus sets a high-speed communication period in the data length 415 field.
S1006: The apparatus checks the number of destinations to which it will transmit information. If there is one destination, the apparatus proceeds to S1007; if there are plural destinations, the apparatus proceeds to S1008.
S1007: The apparatus describes a destination address in the header part 410.
S1008: The apparatus describes multicast addresses in the header part 410.
S1009: The apparatus checks to see whether transmission information requires a response. If a response is required, the apparatus proceeds to S1010; if a response is not required, the apparatus proceeds to S1011.
S1010: The apparatus describes a value representing that a response is required and other necessary values of type in the communication type 414 field.
S1011: The apparatus does not describe a value representing that a response is required, but describes other necessary values of type in the communication type 414 field.
S1012: The apparatus waits for a predetermined time T3, while the facility communication network is not in use.
S1013: The apparatus transmits the header part 410 in which a high speed trigger has been described through low-speed communication.
S1014: The apparatus checks to see whether normal transmission of data is successful. If normal transmission is successful, the apparatus proceeds to
S1015; if normal transmission is unsuccessful, the apparatus returns to S1012 for retransmission. Now, if normal transmission is unsuccessful even though retransmission is repeated plural times, the apparatus terminates retransmission, regarding this situation as an abnormal state.
S1015: The apparatus starts a counter for the high-speed communication period. The apparatus always monitors the counter separately from this flowchart for time counting and counting the number of times that other apparatuses perform high-speed transmission and receiving and changes the counter value accordingly.
S1016: The apparatus transmits communication data through high-speed communication.
S1017: The apparatus checks to see whether normal transmission is successful. If normal transmission is successful, the apparatus proceeds to E (S915 in FIG. 9); if normal transmission is unsuccessful, the apparatus proceeds to S1018 for retransmission. Now, if normal transmission is unsuccessful even though retransmission is repeated plural times, the apparatus terminates retransmission, regarding this situation as an abnormal state.
S1018: The apparatus waits for a predetermined time T2, while the facility communication network is not in use, and proceeds to S1016.

FIG. 11 is a diagram illustrating one example of a flowchart of n-th-time transmission at a high-speed apparatus in the present example. Respective steps in FIG. 10 are described below.

S1101: The apparatus checks to see whether information transmission from it is required. If transmission is required, the apparatus proceeds to S1102; if transmission is not required, the apparatus returns to E (S915 in FIG. 9).
S1102: The apparatus proceeds to S1103 if performing high-speed communication or proceeds to S1115 if performing low-speed communication.
S1103: the apparatus proceeds to S1105 if specifying a period again, revising the current period of high-speed communication, or proceeds to S1005 if not specifying a period.
S1104: The apparatus sets a high-speed communication period (time) in the data length 415 field.
S1105: The apparatus checks the number of destinations to which it will transmit information. If there is one destination, the apparatus proceeds to S1106; if there are plural destinations, the apparatus proceeds to S1107.
S1106: The apparatus describes a destination address in the header part 410.
S1107: The apparatus describes multicast addresses in the header part 410.
S1108: The apparatus checks to see whether transmission information requires a response. If a response is required, the apparatus proceeds to S1109; if a response is not required, the apparatus proceeds to S1110.
S1109: The apparatus describes a value representing that a response is required and other necessary values of type in the communication type 414 field.
S1110: The apparatus does not describe a value representing that a response is required, but describes other necessary values of type in the communication type 414 field.
S1111: The apparatus waits for a predetermined time T2, while the facility communication network is not in use.
S1112: The apparatus transmits communication data through high-speed communication.
S1113: The apparatus checks to see whether normal transmission of data is successful. If normal transmission is successful, the apparatus proceeds to S1114; if normal transmission is unsuccessful, the apparatus returns to S1111 for retransmission. Now, if normal transmission is unsuccessful even though retransmission is repeated plural times, the apparatus terminates retransmission, regarding this situation as an abnormal state.
S1114: The apparatus starts a counter for the high-speed communication period which has been set again. The apparatus always monitors the counter separately from this flowchart for time counting and counting the number of times that other apparatuses perform high-speed transmission and receiving and changes the counter value accordingly, and proceeds to E (S915 in FIG. 9). Now, if a period is not specified in S1104, this step is skipped.
S1115: The apparatus waits till the time-out of the counter for the high-speed communication period, proceeds to F (S811 in FIG. 8), performs processing as is the case in low-speed communication, and returns to S901, when proceeding to S801.

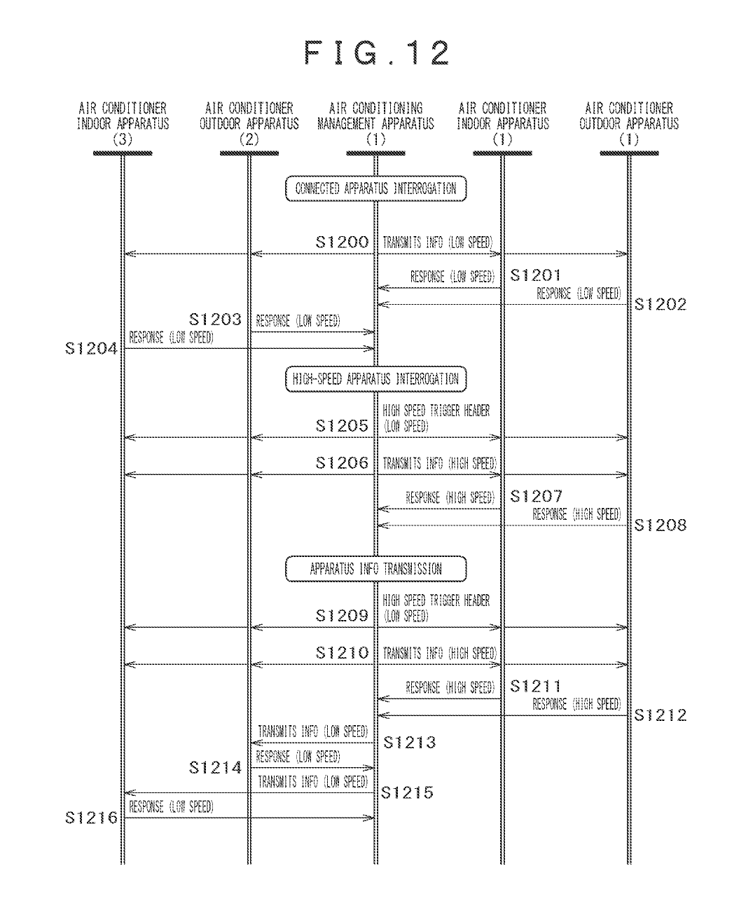

FIG. 12 is a diagram illustrating one example of a communication sequence for interrogating the facility apparatuses connected to the facility communication network 5 to find out which communication speed, low-speed or high-speed each apparatus supports in the present example. Respective steps in FIG. 12 are described below.

S1200: For interrogation to find out what type of the facility apparatuses connected to the facility communication network, an air conditioning management apparatus (1) describes a value representing status acquisition and a value representing that a response is required in the communication type 414 field, describes multicast addresses in the destination address field, and transmits communication information through low-speed communication.
S1201: An air conditioner indoor apparatus (1) describes a value of 0x02 representing an air conditioner indoor apparatus in the apparatus type 411 and transmits back a response through low-speed communication.
S1202: An air conditioner outdoor apparatus (1) describes a value of 0x01 representing an air conditioner outdoor apparatus in the apparatus type 411 and transmits back a response through low-speed communication.
S1203: An air conditioner outdoor apparatus (2) describes a value of 0x01 representing an air conditioner outdoor apparatus in the apparatus type 411 and transmits back a response through low-speed communication.
S1204: An air conditioner indoor apparatus (3) describes a value of 0x02 representing an air conditioner indoor apparatus in the apparatus type 411 and transmits back a response through low-speed communication.
S1205: For interrogation to find out apparatuses that support high-speed communication among the facility apparatuses connected to the facility communication network, the air conditioning management apparatus (1) transmits information comprised of the header part 410 having a value representing that a response is required and a high-speed communication trigger indicating that communication subsequent to transmission of this header is high speed, described in the communication type 414 field, and multicast addresses specified in the destination address 413 through low-speed communication.
S1206: Following the trigger transmission at low speed in S1205, the air conditioning management apparatus (1) describes a value representing status acquisition and a value representing that a response is required in the communication type 414 field, describes a high-speed communication time in the data length field, describes multicast addresses in the destination address field, and transmits communication information through high-speed communication.
S1207: The air conditioner indoor apparatus (1) describes a value of 0x02 representing an air conditioner indoor apparatus in the apparatus type 411 and transmits back a response through high-speed communication.
S1208: The air conditioner outdoor apparatus (1) describes a value of 0x01 representing an air conditioner outdoor apparatus in the apparatus type 411 and transmits back a response through high-speed communication.
Because the air conditioner outdoor apparatus (2) and the air conditioner indoor apparatus (3) are low-speed apparatuses, an undefined value is described in the header information they received in S1205 and they discard such information as abnormal data. As for the information they received in S1206, they regard it as an abnormal signal and do nothing because of high-speed communication.
S1209: To transmit the type of each facility apparatus to high-speed apparatuses connected to the facility communication network, the air conditioning management apparatus (1) transmits to such apparatuses information comprised of the header part 410 having a high-speed communication trigger described in the communication type 414 and multicast addresses specified in the destination address 413 through low-speed communication.
S1210: Following the trigger transmission at low speed in S1209, the air conditioning management apparatus (1) describes a value representing status notification and a value representing that a response is required in the communication type 414 field, describes a high-speed communication time in the data length field, describes multicast addresses in the destination address field, describes a facility information table in the data part 420 following the header, and transmits communication information through high-speed communication.
S1211: The air conditioner indoor apparatus (1) transmits back a response through high-speed communication.
S1212: The air conditioner outdoor apparatus (1) transmits back a response through high-speed communication.
S1213: To transmit the type of each facility apparatus connected to the facility communication network to a low-speed apparatus, after making sure that the facility communication network is not in use for a predetermined time T3, the air conditioning management apparatus (1) transmits the header part 410 having the address of the air conditioner outdoor apparatus (2) described in the destination address 413 and the subsequent data part 420 in which the facility information table is described through low-speed communication.
S1214: The air conditioner outdoor apparatus (2) transmits back a response through low-speed communication.
S1215: After making sure that the facility communication network is not in use for a predetermined time T3, the air conditioning management apparatus (1) transmits the header part 410 having the address of the air conditioner indoor apparatus (3) described in the destination address 413 and the subsequent data part 420 in which the facility information table is described through low-speed communication.
S1216: The air conditioner indoor apparatus (3) transmits back a response through low-speed communication.

In the way described above, it is possible to interrogate the facility apparatuses connected to the facility communication network to find out which communication speed, high-speed or low-speed each apparatus supports and share the found result among the low-speed and high-speed apparatuses. Each facility apparatus can share information as to which communication speed, low-speed or high-speed a peer apparatus supports. Additionally, by using high speed multicast for high-speed communication apparatuses, it is possible to transmit large volume data at a time.

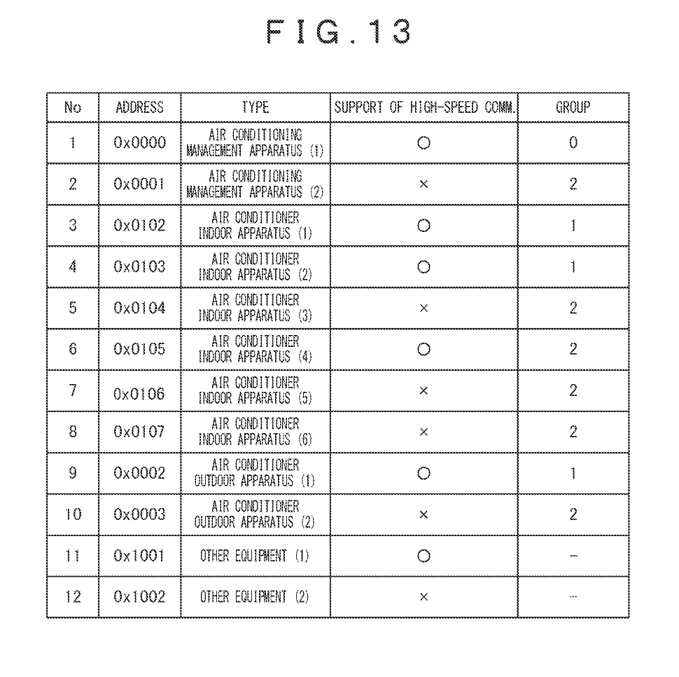

FIG. 13 is a diagram representing one example of an apparatus information table in the present example. This table may be used as data that is transmitted in high-speed information transmission (S1210) in FIG. 12. In this table, the following are described: address specific to apparatus, apparatus type, support of high-speed communication, and apparatus group. For example, in the apparatus group column, described is information that the apparatus is connected to which of the first refrigerant piping 6 and the second refrigerant piping 7 in FIG. 1. For example, information relevant to high-speed communication is transmitted to high-speed apparatuses in high-speed information transmission (S1210) in FIG. 12; whereas, information relevant to high-speed communication is not transmitted to low-speed apparatuses in low-speed information transmission (S1213) in FIG. 12.

In addition, each facility apparatus stores the apparatus information table it received into the storage unit 23. For example, the air conditioner indoor apparatus 2 communicates only with the air conditioning management apparatus 1 and the air conditioner outdoor apparatus 3 and, therefore, it may store the apparatus information table from which other air conditioner indoor apparatuses 2 are deleted.

Now, while the foregoing description has been described assuming a case where the facility communication network 5 is normally placed in a low-speed communication state, switching over to low-speed communication may take place on the assumption of high-speed communication.

As per the foregoing, the present example is so configured as to output communication information to initiate high-speed communication to high-speed apparatuses through low-speed communication, switch over communication speed by the high/low speed switching unit, output communication information by carrying out high-speed communication, and output communication information to low-speed apparatuses through low-speed communication.

In other words, a facility apparatus that is connected to a facility communication network in which a first facility apparatus supporting a first communication speed and a second facility apparatus supporting a second communication speed coexist, the facility apparatus including a communication control unit which controls communication functionality, a transmitting unit which transmits communication information, an output unit which outputs communication information transmitted from the transmitting unit to the facility communication network as a communication signal, an input unit which inputs a communication signal from the facility communication network as communication information, a receiving unit which receives communication information from the input unit, a high/low speed decision unit which decides whether or not communication is initiated at the second communication speed, based on received communication information, and a high/low speed switching unit which switches over an input/output signal speed, based on a result of decision made by the high/low speed decision unit, wherein the facility apparatus is so configured as to output communication information to initiate communication at the second communication speed to the second facility apparatus through communication at the first communication speed, switch over communication speed by the high/low speed switching unit, output communication information through communication at the second communication speed, and output communication information to the first facility apparatus through communication at the first communication speed.

In addition, the facility apparatus is configured to switch over communication speed by the high/low speed switching unit, based on communication information to initiate communication at the second communication speed received from the second facility apparatus through communication at the first communication speed, and receive communication information through communication at the second communication speed.

In addition, communication information to initiate communication at the second communication speed includes information of a period (time) during which communication is to be performed at the second communication speed.

In addition, the facility apparatus is so configured as to output communication information for interrogation to find out second facility apparatus among facility apparatuses to all facility apparatuses connected to the facility communication network through communication at the first communication speed, switch over communication speed by the high/low speed switching unit, and output communication information valid for the second facility apparatus to the second facility apparatus through communication at the second communication speed.

Furthermore, the second communication speed is higher than the first communication speed and the first facility apparatus is a low-speed apparatus and the second facility apparatus is a high-speed apparatus.

By thus implementing bidirectional communication even in a facility communication system where facility apparatuses having different communication speeds are interconnected, availability of the system can be enhanced.

While the example has been described hereinbefore, the present invention is not limited to the described example and various modifications are included therein. For example, the foregoing example has been described in detail to explain the present invention clearly and the present invention is not necessarily limited to its embodiment including all components described.

### REFERENCE SIGNS LIST

1: Air conditioning management apparatus
2: Air conditioner indoor apparatus
3: Air conditioner outdoor apparatus
4: Other equipment
5: Facility communication network
6: First refrigerant piping
7: Second refrigerant piping
8: Host apparatus
20: Low-speed apparatus
21: Control unit
22: Input/output unit
23: Storage unit
24: Load part
25: Communication control unit
26: Transmitting unit
27: Receiving unit
28: Output unit
29: Input unit
30: High-speed apparatus
31: High/low speed decision unit
32: High/low speed switching unit

1. A facility apparatus that is connected to a facility communication network in which a first facility apparatus supporting a first communication speed and a second facility apparatus supporting a second communication speed coexist,
the facility apparatus comprising a communication control unit which controls communication functionality, a transmitting unit which transmits communication information, an output unit which outputs communication information transmitted from the transmitting unit to the facility communication network as a communication signal, an input unit which inputs a communication signal from the facility communication network as communication information, a receiving unit which receives communication information from the input unit, a high/low speed decision unit which decides whether or not communication is initiated at the second communication speed, based on received communication information, and a high/low speed switching unit which switches over an input/output signal speed, based on a result of decision made by the high/low speed decision unit,
wherein the facility apparatus outputs communication information to initiate communication at the second communication speed to the second facility apparatus through communication at the first communication speed, switches over communication speed by the high/low speed switching unit, outputs communication information through communication at the second communication speed, and outputs communication information to the first facility apparatus through communication at the first communication speed; and
wherein communication information to initiate communication at the second communication speed includes information of a period during which communication is to be performed at the second communication speed.

2. A facility apparatus that is connected to a facility communication network in which a first facility apparatus supporting a first communication speed and a second facility apparatus supporting a second communication speed coexist,
the facility apparatus comprising a communication control unit which controls communication functionality, a transmitting unit which transmits communication information, an output unit which outputs communication information transmitted from the transmitting unit to the facility communication network as a communication signal, an input unit which inputs a communication signal from the facility communication network as communication information, a receiving unit which receives communication information from the input unit, a high/low speed decision unit which decides whether or not communication is initiated at the second communication speed, based on received communication information, and a high/low speed switching unit which switches over an input/output signal speed, based on a result of decision made by the high/low speed decision unit,
wherein the facility apparatus switches over communication speed by the high/low speed switching unit, based on communication information to initiate communication at the second communication speed received from the second facility apparatus through communication at the first communication speed, and receives communication information through communication at the second communication speed; and
wherein communication information to initiate communication at the second communication speed includes information of a period during which communication is to be performed at the second communication speed.

3. (canceled)

4. A facility apparatus that is connected to a facility communication network in which a first facility apparatus supporting a first communication speed and a second facility apparatus supporting a second communication speed coexist,
the facility apparatus comprising a communication control unit which controls communication functionality, a transmitting unit which transmits communication information, an output unit which outputs communication information transmitted from the transmitting unit to the facility communication network as a communication signal, an input unit which inputs a communication signal from the facility communication network as communication information, a receiving unit which receives communication information from the input unit, a high/low speed decision unit which decides whether or not communication is initiated at the second communication speed, based on received communication information, and a high/low speed switching unit which switches over an input/output signal speed, based on a result of decision made by the high/low speed decision unit,
wherein the facility apparatus outputs communication information for interrogation to find out the second facility apparatus among facility apparatuses to all facility apparatuses connected to the facility communication network through communication at the first communication speed, switches over communication speed by the high/low speed switching unit, and outputs communication information valid for the second facility apparatus to the second facility apparatus through communication at the second communication speed.

5. The facility apparatus according to claim 1,
wherein the second communication speed is higher than the first communication speed.

6. A facility communication system that is provided with facility apparatuses as described in claim 1, comprising a facility communication network to which facility apparatuses having different communication speeds are connected.
